(19) United States
(12) Patent Application Publication
(10) Pub. No.: US 2015/0243019 A1
(43) Pub. Date: Aug. 27, 2015

(54) ALIGNMENT SYSTEM ARCHITECTURE

(71) Applicant: DWFritz Automation, Inc., Wilsonville, OR (US)

(72) Inventors: Ryan S. Hall, Keizer, OR (US); Joshua Victor Aller, Portland, OR (US)

(21) Appl. No.: 14/631,028

(22) Filed: Feb. 25, 2015

Related U.S. Application Data
(60) Provisional application No. 61/944,705, filed on Feb. 26, 2014.

(51) Int. Cl. G06T 7/00; H04N 5/232; H04N 7/18

(52) U.S. Cl. CPC G06T 7/004; H04N 7/183; H04N 5/23229; G06T 2207/10004; G06T 2207/30244; G06T 2215/16

(57) ABSTRACT

In embodiments, one or more targets may be permanently or removably affixed to one or more components of a mechanical system. A computer guided tuning system may be used to identify the pose, position, or orientation of one or more elements of the mechanical system. The computer guided tuning system may then be able to provide feedback to a user to adjust the mechanical system.

### CROSS REFERENCE TO RELATED APPLICATION

This application claims priority to U.S. Provisional Patent Application No. 61/944,705, filed Feb. 26, 2014 and titled “ALIGNMENT SYSTEM ARCHITECTURE,” the entire contents of which are incorporated by reference herein.

### TECHNICAL FIELD

Embodiments herein relate to system architecture for aligning one or more components of a system.

### BACKGROUND

Modern mechanical systems, for example bicycles, may use multiple gears which may require an indexing shifter. In general, the shifter may require very precise adjustment in order to shift a mechanical linkage such as a bicycle chain to each gear in a rear cassette. Generally, the shifting may be accomplished via a derailleur coupled with the shifter. When the shifter is activated, the derailleur may move slightly and thereby alter the position of the bicycle chain with respect to the cassette. This movement of the derailleur and bicycle chain may cause the bicycle chain to move to a different gear on the cassette.

Calibrating and adjusting the mechanical systems such as the shifter and derailleur may be required for a variety of reasons such as component wear, damage to the bicycle frame, shifter, or derailleur, or changing to a new cassette and/or wheel. However, in many cases, precisely calibrating and adjusting a shifter and derailleur may require extensive trial and error by a person with little calibration experience, or may require paying a person with more calibration experience to adjust the components. In either case, extensive time and/or financial resources may be spent in precisely adjusting the derailleur.

### BRIEF DESCRIPTION OF THE DRAWINGS

FIG. 1 depicts an example system processing flow, in accordance with various embodiments.

FIG. 2-A depicts an example side-view of various targets coupled with a mechanical system such as a bicycle, in accordance with various embodiments.

FIG. 2-B depicts an example rear-view of various targets coupled with a mechanical system such as a bicycle, in accordance with various embodiments.

FIG. 2-C depicts an example front-view of various targets coupled with a mechanical system such as a bicycle, in accordance with various embodiments.

FIG. 3 depicts an example system state diagram, in accordance with various embodiments.

FIG. 4 depicts an example interaction diagram, in accordance with various embodiments.

FIG. 5 schematically illustrates an example system that may be used to practice various embodiments described herein.

### DETAILED DESCRIPTION OF EMBODIMENTS OF THE INVENTION

In the following detailed description, reference is made to the accompanying drawings that form a part hereof, and in which are shown by way of illustration embodiments that may be practiced. It is to be understood that other embodiments may be utilized and structural or logical changes may be made without departing from the spirit or scope of the present disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

The tuning system described herein is built on a system architecture that may be readily applied to computer guidance applications in other industries. As such, it is described herein through the use of general terms, but also with reference to an embodiment specific to tuning a bicycle derailleur. The system may guide a user through a complex or adaptive procedure which may be driven mainly by computer vision input. In the tuning system, guidance may be given to the user in the form of spoken prompts as well as text and graphic instructions displayed on a computer screen, however, guidance may additionally or alternatively be given in any number of forms, including other visual, auditory, or haptic forms of feedback.

Although computer vision is the main form of input to the system, the tuning system may also solicit input from any number of computer sensors, including touch screen, auditory or voice recognition, position or orientation sensors (including but not limited to GPS, accelerometer, gyroscope, near field communications, or custom sensing accessories). Input to the system may also potentially be in the form of information sent to a computer device across a computer network.

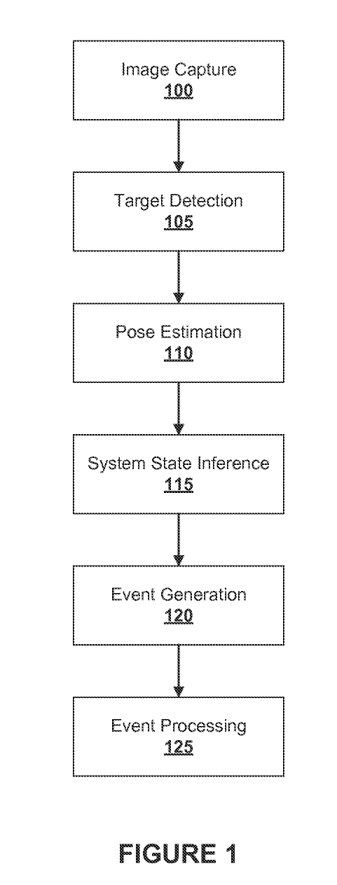

FIG. 1 depicts an example system processing flow that may be used to tune or otherwise adjust a mechanical system as described herein. Initially, images such as raster images may be captured by a camera coupled with a computer or computing device such as a smart phone camera at 100. The image(s) may then be analyzed for visual targets at 105. These targets may be derived of rigid bodies with fiducial marks or they may be comprised of recognizable features of the system being analyzed. For example, if the system is a car, then the targets may be derived from different elements of the car such as an air cleaner, power brake booster cap, or other elements of the car. In some embodiments the camera may first take an image of a bar code or some other designator that may be affixed to the car, which may allow the camera to identify a make, model, or configuration of the car or mechanical system, such as to provide certain pre-defined parameters, measurements, etc. The targets may be identified, and then a pose such as a 3-D pose of one or more of the targets, or a position of one or more of the targets, may then be estimated or calculated at 110. Specifically, the pose of one or more of the targets may be calculated relative to the camera that took the images at 100. From the pose(s) of the target(s), the state of the mechanical system may then be inferred at 115. An example of such a mechanical system may be a bicycle as described above. An example of a state of the mechanical system may be the current gear that the bicycle is in. Specific events may then be generated at 120 based on changes to the system state, e.g. a change of gear, and these generated events, or indications of the generated events, may be sent to a controller for event processing at 125. In some embodiments, the current node of a finite state machine that includes the different system states may act as the controller, and may take specific action such as prompting the user, or transitioning to a new state node triggered by the processing of the generated events at 125. In addition to receiving the generated events, or the indications of the generated events, the controller may receive an indication of the full system state which it may use contextually to interpret the incoming generated events. The different elements of the process are described in greater detail below.

### Image Capture

Images such as raster images may be captured from one or more camera devices at 100. Images may be captured from a camera such as a camera coupled with or integrated into a computer, a personal digital assistant (PDA), a mobile phone, a smartphone, or some other type of camera. In the embodiment of a smartphone, for example, images may be captured from the smartphone front facing camera. Image capture may occur asynchronously, that is at a progression of different times, and each image may be processed through the stages of the process of FIG. 1. In other embodiments, a plurality of images may be captured from different angles and processed concurrently with one another or sequentially. In some embodiments, a plurality of images may be captured asynchronously, but then processed concurrently with one another. In embodiments, the captured images may be full color or monochrome.

### Target Detection

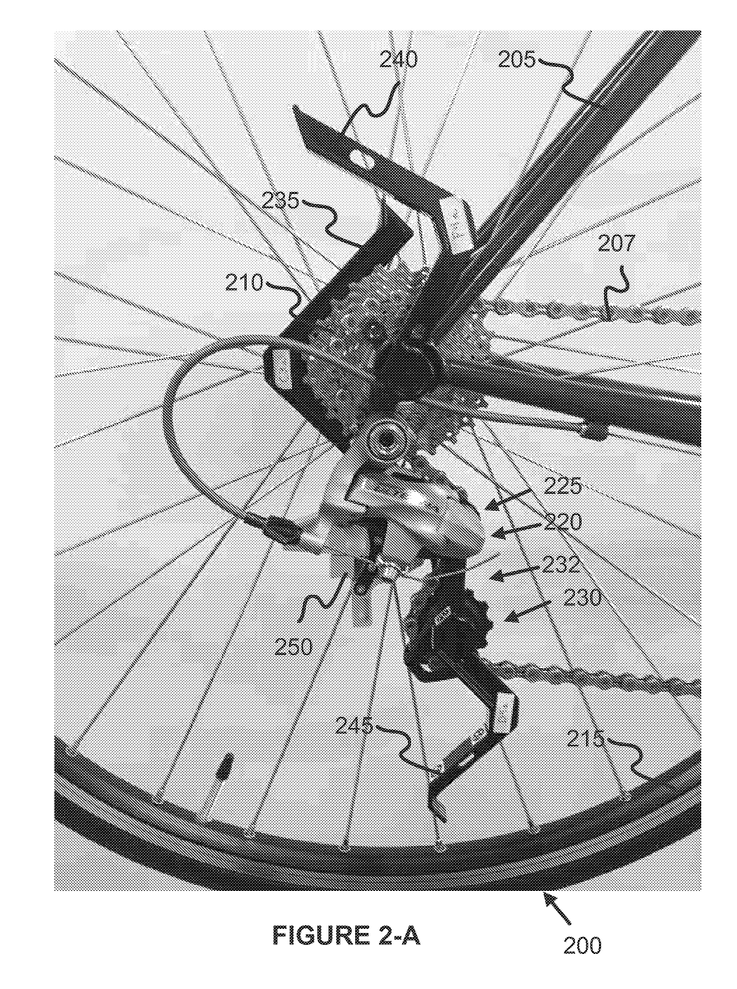

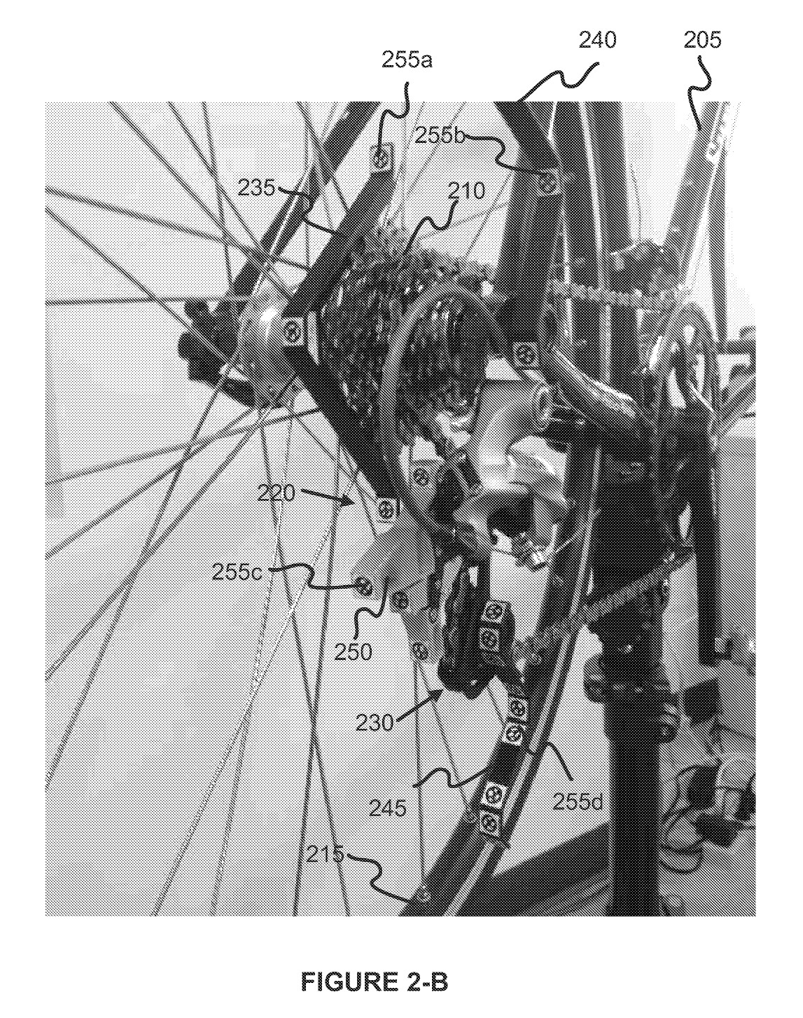

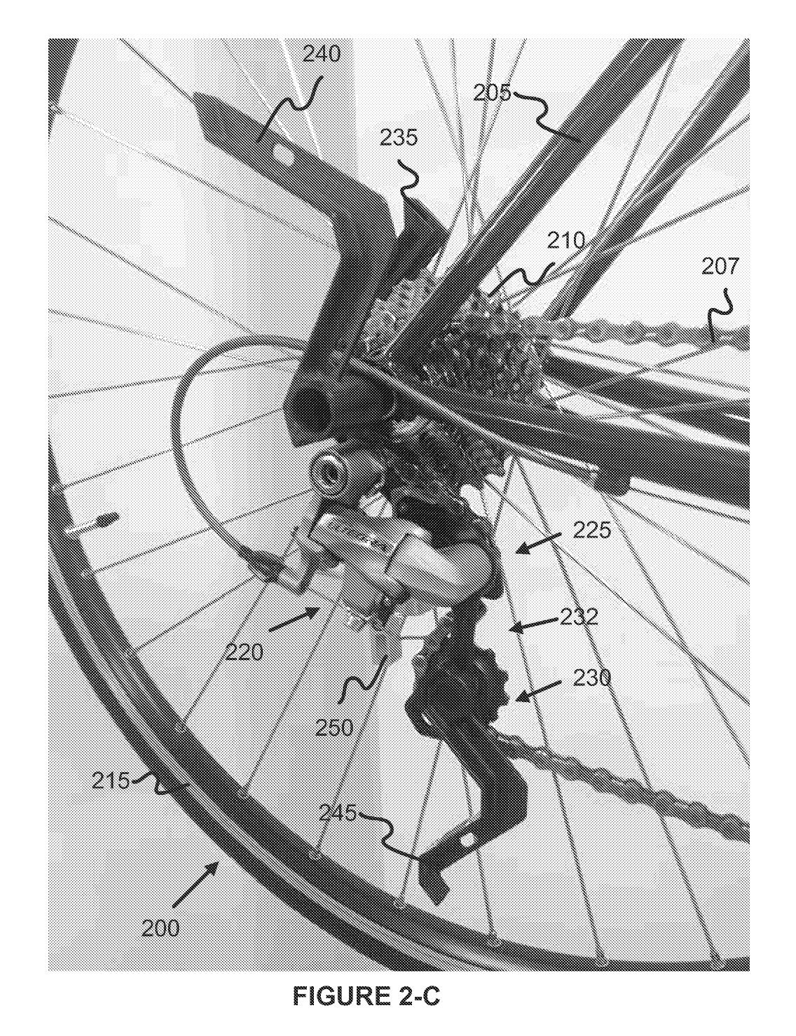

In order to perform the target detection 105, a plurality of physical targets may be attached to a mechanical system such as a bicycle in order to measure the position and orientation of different parts of the bicycle. FIG. 2-A depicts a side view of a mechanical system 200 such as a bicycle coupled with a plurality of targets. The mechanical system 200 may include a bicycle frame 205. The bicycle frame 205 may be coupled with a cassette 210. The cassette may include a number of gears, and generally the gear with the greatest circumference is considered the “lowest” gear while the gear with the smallest circumference may be considered the “highest” gear. In some embodiments, the lowest gear may be the gear that is closest to the bicycle wheel 215, while the highest gear is the gear that is further from the bicycle wheel 215. The cassette 210 may be coupled with a bicycle chain 207 configured to rotate the cassette 210. The cassette 210 may be fixedly coupled with the wheel 215 such that when the cassette 210 rotates, the wheel 215 rotates. The chain 207 and frame 205 may be coupled with a derailleur 220 configured to move the chain 207 with respect to the cassette 210. The derailleur 220 may include a jockey pulley 225 and an idler pulley 230, which may also be called an “upper” pulley and a “lower” pulley, respectively. The element of the derailleur 220 coupling the idler pulley 230 to the remainder of the derailleur 220 may be referred to as a derailleur cage 232.

In embodiments, one or more targets may be attached to the frame 205, the cassette 210, and/or the derailleur 220. For example, a frame target 240 may be coupled with the frame 205, for example near the skewer that couples the cassette 210 and wheel 215 to the frame 205 as shown, though the frame target 240 may be coupled with the frame 205 at other locations in other embodiments. A cassette target 235 may be coupled with the cassette 210. A jockey target 250 may be coupled with the derailleur 220 at a position near the jockey pulley 225 or some other position. A derailleur target 245 may be coupled with the derailleur 220, for example near the idler pulley 230 or at some other position. In some embodiments, a calibration target (not shown) may be used. The calibration target may not attach to the system 200, but instead may be used for calibration of the intrinsic parameters of the camera taking the digital images. Additional or alternative targets may be used in other embodiments. For example, a plurality of frame, derailleur, jockey, and/or cassette targets may be used in other embodiments.

FIG. 2-B depicts a rear-view of the configuration of the bicycle and targets as 2-A including the frame 205, chain 207, cassette 210, wheel 215, derailleur 220, idler pulley 230, cassette target 235, frame target 240, derailleur target 245, and jockey target 250. In some embodiments, the targets may have one or more fiducial markers. For example, the cassette target 235 may have one or more fiducial markers such as fiducial marker 255a. The frame target 240 may have one or more fiducial markers such as fiducial marker 255b. The jockey target 250 may have one or more fiducial markers such as fiducial marker 255c. The derailleur target 245 may have one or more fiducial markers such as fiducial marker 255d.

FIG. 2-C depicts a view from a forward position of the mechanical system 200, which in this embodiment may be a bicycle, showing the configuration of the various targets and elements of the mechanical system 200. Specifically, FIG. 2-C depicts the frame 205, chain 207, cassette 210, wheel 215, derailleur 220, jockey pulley 225, idler pulley 230, derailleur cage 232, cassette target 235, frame target 240, derailleur target 245, and jockey target 250.

In general, a minimum of three fiducial markers may be used to locate the target's position and orientation (pose). However, in some embodiments targets such as the derailleur target 245 may contain additional fiducial markers such as fiducial marker 255d so that the target may be located from a wider range of viewing angles. In some embodiments, these additional fiducial markers may increase the accuracy of pose determination from single or multiple images.

The target detection process may be broken down into stages. Initially, fiducial markers such as fiducial markers 255a-d may be located in an image captured during the image capture 100. In one embodiment, the fiducial markers may be utilized to precisely locate 2-D points in the image. The fiducial markers may be detected in monochrome images, so a preliminary stage to convert a color image into monochrome intensity may occur prior to target detection 105. By averaging points on the perimeter of the outer circle of the fiducial markers, a very accurate (sub-pixel) 2-D coordinate of each fiducial marker may be calculated.

### Pose Estimation

After the target detection 105, a full 3-D pose (position and orientation) relative to the camera may then be estimated at 110 for one or more of the targets in an image such as the cassette target 235, frame target 240, derailleur target 245, and jockey target 250. Pose may be calculated via a number of methods. For instance, software packages such as OpenCV may contain a number of pose solving algorithms (CV_ITERATIVE, CV_P3P, and CV_EPNP). A 3-D pose solver may be used to solve for pose with a closed form solution.

Using a camera calibration procedure, a number of intrinsic lens parameters may have been previously calculated such that the projection from 3-D space to a 2-D image coordinate may be precisely modeled. In one embodiment, an iterative solver may be used to minimize the reprojection error, which may be measured for example as root mean square (rms) error, to calculate the pose of a target. In some embodiments, these camera or lens parameters may be based on one or more targets that have, respectively, four or more fiducial markers.

Generally, a pose may consist of six degrees of freedom, for example X,Y,Z translation and X,Y,Z rotation. An initial pose for a target may be an estimate or simply be an arbitrary starting point. The initial pose for the target may be supplied to a minimization algorithm, and the minimization algorithm may adjust the six degrees of freedom of the pose to find the extrinsic parameters that yield a relatively low or lowest reprojection residual. A pose calculation may be potentially ambiguous. Specifically, there may be two minima of lowest reprojection error, one where the target is facing the camera and one where the target is facing away from the camera. Because the target may be known to be facing the camera, if the solver returns a pose facing away from the camera then the pose is rotated 180 degrees and then the iterative solver may then minimize from the new starting pose.

### System State Inference

Once target poses have been identified, system state may be inferred at 115. For example, in the embodiment of a bicycle tuning system, the system state may be described through many measurable properties, including:
The current rear sprocket gear of the cassette 210.
The current front sprocket gear of a front cassette (not shown).
The shortest distance from the jockey pulley 225 to the plane of the largest sprocket of the cassette 210.
The angle of the derailleur cage of the derailleur 220.
The list of targets which are visible.

In order to infer these states, a number of calculations may be performed. Several of these measurable properties are described below. In some embodiments, these inferences may be based only on two targets. For example, the system state inference may be based on the cassette target 235, and the jockey target 250. In other embodiments, these inferences may be based on additional targets.

### Determination of Rear Sprocket Gear

To determine which gear the bicycle is in, the alignment between the jockey pulley 225 and the different gears of the cassette 210 may be examined. However, the cassette target 235 and jockey target 250, which may respectively directly measure the position of the cassette 210 and jockey 225 pulley, may not be able to be attached to the bicycle while the bicycle is shifting because they may interfere with the shifting operation. In order to overcome this limitation, a calibration operation may be first performed on the bicycle to determine the spatial relationship (3D transform) between the cassette target 235 and the frame target 240 (‘C-F’ transform) and the jockey target 250 and the derailleur target 245 (‘J-D’ transform). This calibration may need to be performed only once so long as the mounts for the derailleur target 245 and frame 240 target are not moved.

Specifically, targets such as the cassette target 235, frame target 240, derailleur target 245, and jockey target 250 may be comprised of a rigid body containing multiple fiducial point markers such as fiducial markers 255a-d. Each marker may be assigned an X,Y,Z coordinate relative to the target's coordinate system. An interpose solver may be used to identify a spatial relationship (3-D “interpose” transform or full attitude pose) between two targets, or between multiple targets, based on observations gathered from multiple photographs of the set of targets.

This interpose solver may have many potential uses. For example a very accurate transform describing the spatial relationship between targets may be obtained by optimizing the pose to best match the results observed in multiple photographs taken from different viewing angles.

There may also be benefits from using multiple images captured from the same viewing angle, e.g. from the same camera in the same position. Specifically, given the inherent noise and inaccuracies of 2-D point location, a more accurate interpose transform may be obtained by calculating this relative transform as a best fit of a set of images. To use a further example that may be specific to the bicycle derailleur tuning process, it may be useful to find the average transform between the cassette target 235 and the frame target 240. Given that cassettes such as cassette 210 may not be perfectly concentric on the wheel hub and may exhibit a wobble when the hub they are mounted to rotates, a phenomenon that may be called the wheel 215 being “out of true,” it may be desirable to find a best-fit transform that averages the wobble. This may be accomplished by having the user spin the bicycle's rear wheel 215 while capturing a set of images of the cassette target 235 and the frame target 240.

In order to find the most accurate interpose transform, an iterative approach may be used that takes into account all images of the targets. In order to illustrate the algorithm, assume that there are two targets, for example, ‘A’ and ‘B’, and it is desired to find an accurate interpose between the two targets. It may be known that the spatial relationship between ‘A’ and ‘B’ is consistent in all images, therefore the problem may be restated as that of finding the pose of target ‘A’ for each image (“the ‘A’ pose), plus an ‘A’-to-′B′ pose that is shared between all images. This ‘A’-to-‘B’ pose may simply be the pose of target ‘B’ (“the ‘B’ pose”) relative to the pose of ‘A’. In embodiments, each pose may be represented by a 4×4 matrix, translation vector and Euler rotation angles, or a translation vector and quaternion.

It may be assumed that each pose is rigid and consists of only six degrees of freedom as described above. Therefore, if there are 10 images showing ‘A’ and ‘B’ targets, then there may be a total of 66 degrees of freedom to optimize—6×10 degrees of freedom for ‘A’, and an additional 6 degrees of freedom for the ‘A’-to-′B′ pose that is common to all images. This ‘A’-to-‘B’ pose transform may be the desirable interpose result. In embodiments the additional degrees of freedom, e.g. the 60 degrees of freedom of ‘A’ may be useful to facilitate solution of the problem.

Initially, approximations may be made for all degrees of freedom. The poses for ‘A’ in each image may be calculated through pose estimation techniques discussed earlier in this text. The initial guess at the ‘A’-to-′B′ pose transform may be estimated by solving for the ‘B’ pose and then multiplying the 4×4 matrix of ‘B’ pose by the inverse of the 4×4 matrix for ‘A’ pose in any single image.

The interpose solver may then minimize the total reprojection error observed across all images. Reprojection error may be calculated by transforming all fiducial points on target ‘A’ into 3-D coordinates relative to the camera for each image. Next, the 3-D coordinates may be projected (using intrinsic lens parameters) into image coordinates. Each projected image coordinate may be calculated and the observed location of the correlated fiducial marker in the image may be identified. A reprojection error may then be calculated by summing the squares of the distances between the projected and observed locations. The same procedure may be performed on the ‘B’ target. The ‘B’ fiducial points may then be transformed into 3-D camera coordinates by using the concatenation of the ‘A’ and ‘A’-to-′B′ pose transforms. These calculated camera coordinates may then be projected by the intrinsic lens parameters into image coordinates, and the squared distance between the projected image coordinates and observed image coordinates are added to the running total of reprojection error.

A nonlinear optimizer may then be used to adjust all degrees of freedom in order to minimize this reprojection error. Any number of solver algorithms may be used for this task, for example, the Nelder-Mead algorithm (downhill simplex method) the Levenberg-Marquardt algorithm, or other algorithms may be applied.

In embodiments, the poses between any number of rigid targets may be found with the interpose process described above. For example, if an additional ‘C’ target was used, an additional six degrees of freedom for the ‘A’-to-′C′ transform may be used. If there were 10 images containing targets ‘A’, ‘B’ and ‘C’, then 72 degrees of freedom (6×10 for ‘A’, 6 for ‘A’-to-′B′, and 6 for ‘A’-to-′C′) may be optimized. Reprojection error may then be the total squared distance between observed image coordinates of fiducial markers and the projected image coordinates of all three targets in one or more, or all, of the 10 images.

In some embodiments, it may not be necessary that all targets (or fiducial markers) be present in all images. In these embodiments, the total reprojection error may be constituted only from the targets (and fiducial markers) that are present in the captured images.

Once calibrated, the cassette target 235 and the jockey target 250 may not be necessary to determine the positions of the cassette 210 and jockey pulley 225, respectively. The derailleur target 245 and frame target 240 may be located, and then the poses of these targets may be concatenated with the pre-calculated ‘C-F’ and ‘J-D’ poses described above in order to determine the poses of the largest sprocket of the cassette 210 (e.g. the lowest gear or first gear) and the jockey pulley 225 relative to the camera.

The position where the chain 207 detaches from the jockey pulley 225, referred to as the “jockey-point”, may then be determined, and the normal distance between that point and the plane of the largest sprocket of the cassette 210, referred to as the “jockey-distance,” may be determined. If the jockey-distance is zero or approximately zero, the jockey pulley may be directly aligned with the largest sprocket of the cassette 210. In embodiments, the spacing between sprockets of the cassette 210 may be known, for example it may be 0.1555 inches in common cassettes, and there it may be possible to find the current bicycle gear by determining which sprocket of the cassette 210 the jockey-point is closest to. The value of 0.1555 inches is merely one example and in other embodiments the spacing between sprockets of the cassette 210 may be larger or smaller.

### Determination of Front Sprocket Gear

The derailleur target 245 may also indicate the angle at which the derailleur cage 232 is hanging. Given that it may be known what gear the rear derailleur 220 is in, this angle of the derailleur cage 232 may indicate the status of the front derailleur (not shown) of the bicycle. For example, when the front derailleur is on the large sprocket of the front cassette (not shown), typically referred to as being in a high gear, the 207 may pull the derailleur cage to a more forward position than when the front derailleur is on a smaller sprocket, typically referred to as being in a low gear. Through a calibration procedure, these angles may be measured and then later the front derailleur gear may readily be recognized.

### Determination of User Activity

System state may also include prior settings of any measurements so that additional information may be extracted. For example, by seeing that the jockey-distance is consistent over a number of captured images, it may be reasonable to infer that the user has stopped adjusting the bicycle gearshift. By seeing that the gear number has increased, it may be reasonable to infer that the user has shifted up.

### Event Generation

Based on the changes in system state, and the related inferences made at 115, one or more events may be generated at 120. Specifically, the changes in system state may be described by events such as:
didChangeGear—User has changed gears on the rear derailleur 220.
didShiftUp—User has shifted up on the rear derailleur 220.
didShiftDown—User has shifted down on the rear derailleur 220.
didRepeatMeasurement—Jockey distance has not changed since last image.
didChangeMeaurement—Jockey distance has changed.
didChangeFrontGear—Front derailleur gear has changed.
didChangeToLargeFrontGear—User has shifted to large gear on front derailleur.
didChangeToSmallFrontGear—User has shifted to small gear on front derailleur.

The events discussed above are merely examples and additional or alternative events may be used. For example, additional events may describe what information is available from the current state:
didCapturelmage—An image was captured and can be analyzed.
didDetectCassetteTarget—The cassette target 235 is visible.
didNotDetectCassetteTarget—The cassette target 235 is not visible.
didDetectFrameTarget—The frame target 240 is visible.
didNotDetectFrameTarget—The frame target 240 is not visible.
didDetectJockeyTarget—The jockey target 250 is visible.
didNotDetectJockeyTarget—The jockey target 250 is not visible.
didDetectDerailleurTarget—The derailleur target 245 is visible.
didNotDetectDerailleurTarget—The derailleur target 245 target is not visible.

By examining the current system state and noting changes from a previous system state such as the last system state, a list of events may be generated at 120. These events may then be passed to the current controller which may choose to respond or not respond to any event type.

### Event Processing

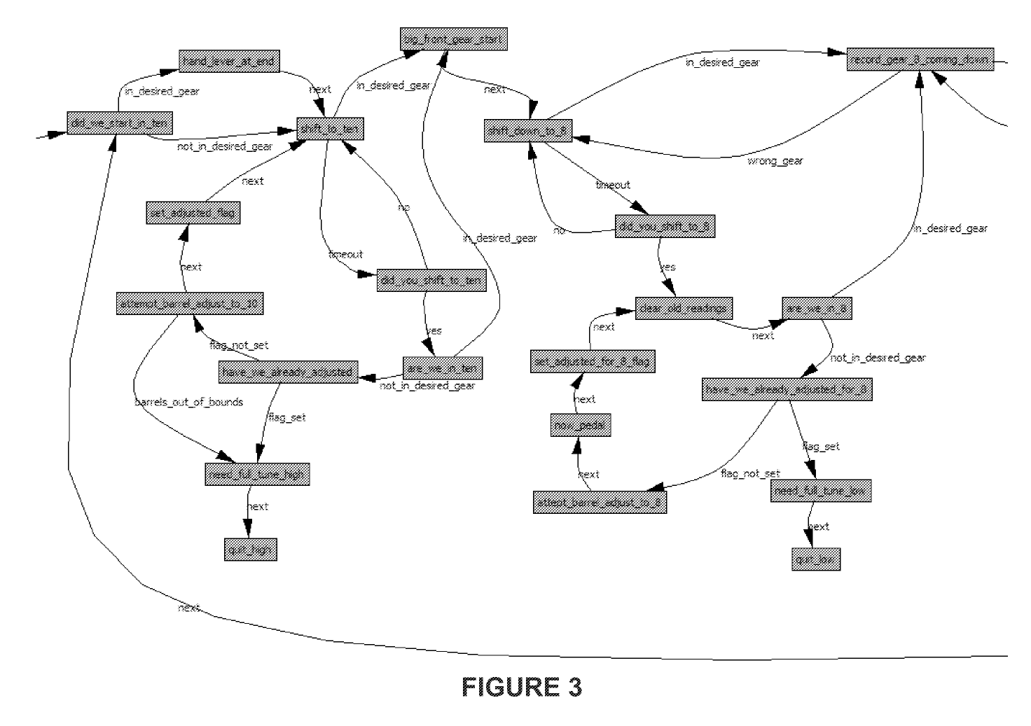

The generated events may then be processed at 125. Specifically, an application may be described by a state map that organizes the stages necessary to guide the user through the tuning process. Each stage of the state map may have a specific goal, for example, getting the user to shift to a specific gear, recording a measurement, or asking the user to turn an adjusting screw. An example of a state map is depicted in FIG. 3. It will be understood that FIG. 3 only depicts a portion of an overall process or state map, and is used herein as a non-limiting example.

The state map may contain ‘nodes’, which may be designated by rectangular boxes in FIG. 3, as well as ‘transitions’ which may be designated by arrows in FIG. 3. Each node may have a name to identify it, as well as a ‘class’ which may define its behavior. Specifically, classes may be implemented in an object-oriented fashion so that they can inherit common behavior from parent classes. Classes may implement functions named after the events to which they respond. If a class does not respond to an event, control may be yielded up the class-inheritance chain to parent classes to see if any respond to that event.

Some examples of classes may include:
ShiftToGear—Instructs the user to shift to a specific gear, monitor gear and check for stopping short or overshooting.
RecordGear—Record the jockey-distance measurement in the desired gear.
SetFlag—Set a flag which we can later check (with the CheckFlag class) to direct the user flow.

Nodes may also contain configuration information that configure the class. For example, the ShiftToGear class may be configured with the desired gear, the direction the user must shift into the gear, and how the instructions will be given. These configuration properties may be contained within a dictionary that may be passed into the class on its construction.

In embodiments, nodes may also contain transitions to other nodes. For example, in FIG. 3 the transitions between nodes may be displayed as named. The names may correspond with transitions supported by the node's class. For example, the ‘shift_to_ten’ node may be of class ShiftToGear and may have transitions called ‘in_desired_gear’ and ‘timeout’. When the class recognizes that the user has shifted to the desired gear (as specified by the node configuration), the node may trigger a transition called ‘in_desired_gear’ which may cause the node pointed to by a transition of this name to become the new current node and the controller receiving all events. In some embodiments, classes may also support on_entry and on_exit events for performing work independent of events tied to specific observations.

As described above, there are several variations of processes that may be used in different embodiments. Additionally, the processes discussed above are described with reference to a bicycle, but may be easily applied to other mechanical systems used in industries such as:
Automotive repair
Production assembly requiring precision alignment
Construction
In situ satellite repair
Guiding airplanes into terminals
Satellite dish alignment
Gem cutting
Wheel alignment
Harbor pilot guidance
In situ machine calibration

In some embodiments, the processes described above may be well suited to industrial automation or market areas where orientation and/or location of bodies may be desired. For example, with regard to industrial automation, the above described processes may be useful when performed with respect to:
Conveyor pick and place.
Computer numerical control (CNC) and metrology axis tuning.
Inexpensive coordinate-measuring machines (CMMs). For example, the above described technology could allow for relatively inexpensive CMMs that are mobile or even hand-held.
Coarse object finding for precision (e.g., reducing the cost of tooling of precision parts).
Robotic arm pick and place.
Assembly lines.

In some embodiments, the processes described above may be well suited to the following market and/or product areas:
Locating a person in various environments such as at a concert, at events with a large number of people, in mountain areas, at a shopping mall, or at other areas.
An automated gas pump station where the relative position or pose of elements such as a car, a gas tank, and/or a gas pump may be useful.
Micro-navigational and/or docking application such as may be employed by a garbage truck locating and picking up a trash bin, the pick-up or drop-off of construction materials, or other applications.
Grocery carts with targets that assist shoppers in locating various items.
Physical therapy and/or chiropractic measurements such as range of motion measurements.
Athletic fit and training applications such as a bicycle calibration (“bike fit”), golf instruction such as stance and/or swing instruction, dance instruction, etc.
Automotive, marine, and/or aerospace docking and/or parking.

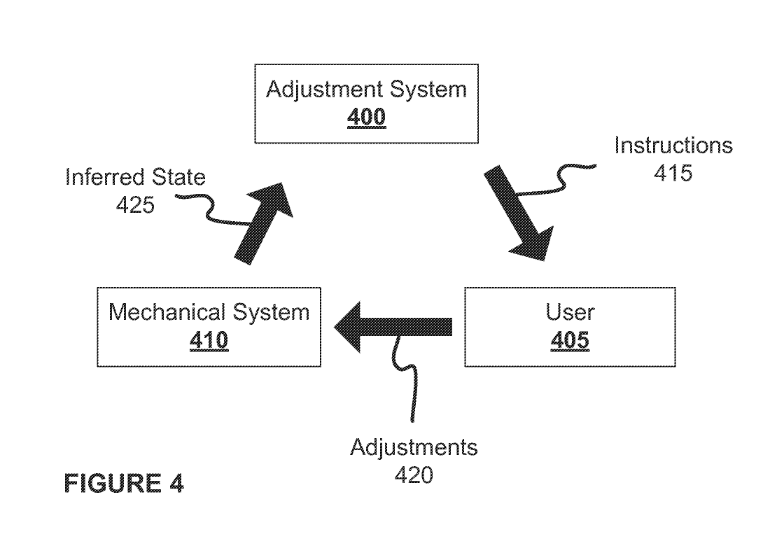

FIG. 4 depicts an example of an interaction flow in accordance with the processes described herein. As described, an adjustment system 400 that may be able to perform some or all of the elements of FIG. 1 may be able to provide instructions 415 to a user 405. The instructions 415 may be, for example, to shift a gear in the mechanical system 410, to adjust a screw or knob in the mechanical system 410, or some other instruction 415.

In response, the user 405 may make an adjustment 420 to the mechanical system 410 in accordance with the instructions. For example, the user may shift the directed gear or adjust the specified screw or knob.

The mechanical system 410 may be changed, and so the adjustment system 400 may be able to identify an inferred state 425 of the system as described above at FIG. 3. For example, the system may change to a next node in a state diagram. The adjustment system 400 may identify this change and determine new instructions 415 which it can provide to the user.

It will be recognized that the above description of the interaction flow is merely one example. Specifically, in this embodiment the interaction flow is based on the premise that the adjustment system 400 may not directly identify an action of the user 405, but rather is reliant upon observing a change in the mechanical system 410 which can be used to identify an inferred state 425 and generate new instructions 415 based on that inferred state 425. In other embodiments, the adjustment system 400 may be able to directly identify an action or movement of the user 405, or the interaction flow may include additional or alternative elements.

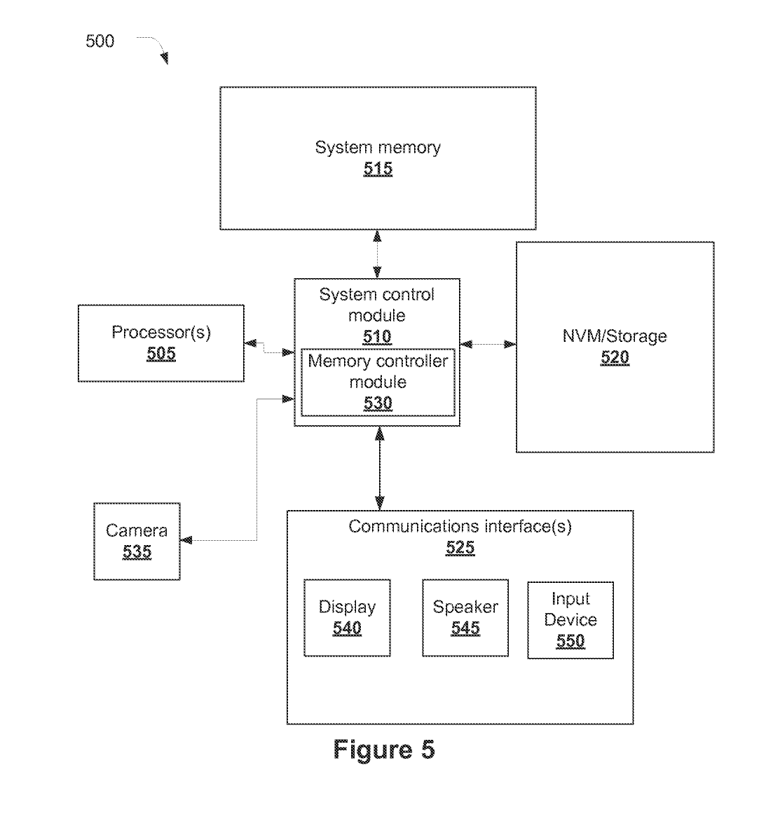

Embodiments of the present disclosure may be implemented into a system using any suitable hardware and/or software to configure as desired. FIG. 5 schematically illustrates an example system 500 that may be used to practice various embodiments described herein. FIG. 5 illustrates, for one embodiment, an example system 500 having one or more processor(s) 505, system control module 510 coupled to at least one of the processor(s) 505, system memory 515 coupled to system control module 510, non-volatile memory (NVM)/storage 520 coupled to system control module 510, and one or more communications interface(s) 525 coupled to system control module 510. In some embodiments, the system 500 may include a camera 535 that may be configured to take one or more images as described above. Additionally, the communications interface(s) 525 may be coupled with one or more of an output device such as a display 540 and/or a speaker 545 to communicate one or more instructions to a user of the system 500. In embodiments, the communications interface(s) 525 may include an input device 550 to receive input from the user of the system 500. The input device 550 may be or include a touchscreen, a keyboard, or some other form of user input.

In some embodiments, the system 500 may include one or more computer-readable media (e.g., system memory or NVM/storage 520) having instructions and one or more processors (e.g., processor(s) 505) coupled with the one or more computer-readable media and configured to execute the instructions to implement a module to perform actions described herein.

System control module 510 for one embodiment may include any suitable interface controllers to provide for any suitable interface to at least one of the processor(s) 505 and/or to any suitable device or component in communication with system control module 510.

System control module 510 may include memory controller module 530 to provide an interface to system memory 515. The memory controller module 530 may be a hardware module, a software module, and/or a firmware module.

System memory 515 may be used to load and store data and/or instructions, for example, for system 500. System memory 515 for one embodiment may include any suitable volatile memory, such as suitable DRAM, for example. In some embodiments, the system memory 515 may include double data rate type four synchronous dynamic random-access memory (DDR4 SDRAM).

System control module 510 for one embodiment may include one or more input/output (I/O) controller(s) to provide an interface to NVM/storage 520 and communications interface(s) 525.

The NVM/storage 520 may be used to store data and/or instructions, for example. NVM/storage 520 may include any suitable non-volatile memory, such as flash memory, for example, and/or may include any suitable non-volatile storage device(s), such as one or more hard disk drive(s) (HDD(s)), one or more compact disc (CD) drive(s), and/or one or more digital versatile disc (DVD) drive(s), for example. In some embodiments,

The NVM/storage 520 may include a storage resource physically part of a device on which the system 500 may be installed or it may be accessible by, but not necessarily a part of, the device. For example, the NVM/storage 520 may be accessed over a network via the communications interface(s) 525.

Communications interface(s) 525 may provide an interface for system 500 to communicate with a user, for example by providing visual cues via the display 540 and/or audio cues via the speaker 545. In some embodiments, the communications interface(s) 525 may include the input device 550 to receive commands from the user, for example in response to prompts provided by the display 540 and/or speaker 545.

For one embodiment, at least one of the processor(s) 505 may be packaged together with logic for one or more controller(s) of system control module 510, e.g., memory controller module 530. For one embodiment, at least one of the processor(s) 505 may be packaged together with logic for one or more controllers of system control module 510 to form a System in Package (SiP). For one embodiment, at least one of the processor(s) 505 may be integrated on the same die with logic for one or more controller(s) of system control module 510. For one embodiment, at least one of the processor(s) 505 may be integrated on the same die with logic for one or more controller(s) of system control module 510 to form a System on Chip (SoC).

In some embodiments the processor(s) 505 may include or otherwise be coupled with one or more of a graphics processor (GPU) (not shown), a digital signal processor (DSP) (not shown), wireless modem (not shown), multimedia circuitry (not shown), sensor circuitry (not shown), and/or global positioning satellite (GPS) circuitry (not shown).

In various embodiments, the system 500 may be or include, but is not limited to, a server, a workstation, a desktop computing device, or a mobile computing device (e.g., a laptop computing device, a handheld computing device, a tablet, a netbook, a smartphone, a gaming console, etc.). In various embodiments, the system 500 may have more or fewer components, and/or different architectures. For example, in some embodiments, the system 500 may include one or more of a non-volatile memory port, multiple antennas, graphics chip, application-specific integrated circuit (ASIC), and speakers.

What is claimed is:

1. One or more non-transitory computer-readable media comprising instructions to cause a computing device, upon execution of the instructions by one or more processors of the computing device, to:
capture, by a camera of the computing device, an image of a mechanical system;
detect one or more targets in the image, the targets coupled with the mechanical system and respective targets having a plurality of fiducial markers;
estimate a respective pose of the one or more targets in the image based on the fiducial markers;
infer, based at least in part on the respective estimated pose of the one or more targets, a state of the mechanical system;
generate, based at least in part on the state, an event; and
process the event.

2. The one or more non-transitory computer-readable media of claim 1, wherein the mechanical system is a rear derailleur of a bicycle.

3. The one or more non-transitory computer-readable media of claim 1, wherein the instructions are further to estimate the pose of one of the one or more targets based at least in part on a spatial relationship of the one of the one or more targets with another of the one or more targets.

4. The one or more non-transitory computer-readable media of claim 1, wherein the instructions to process the event are instructions to provide, by the computing device based at least in part on the event, feedback to a user to adjust an element of the mechanical system.

5. The one or more non-transitory computer-readable media of claim 4, wherein the instructions are further to provide the feedback via a display or a speaker of the computing device.

6. The one or more non-transitory computer-readable media of claim 4, wherein the instructions are further to identify, by the camera based on the feedback, a change of a pose of one of the one or more targets in the image by the user.

7. The one or more non-transitory computer-readable media of claim 6, wherein the event is a first event and the instructions are further to:
estimate, based on the change, a new pose of the one of the one or more targets in the image;
infer, based on the new pose, a new state of the mechanical system; and
generate, based on the new state, a second event.

8. The one or more non-transitory computer-readable media of claim 1, wherein the respective targets have three or more fiducial markers.

9. The one or more non-transitory computer-readable media of claim 1, wherein the instructions to estimate the respective pose of the one or more targets include instructions to estimate the respective pose of the one or more targets based on one or more parameters related to the camera.

10. The one or more non-transitory computer-readable media of claim 1, wherein the parameters are based on an image of a calibration target with at least four fiducial markers.

11. A system comprising:
a camera to capture an image of a mechanical system; and
a processor coupled with the camera, the processor to:
detect one or more targets in the image, the targets coupled with the mechanical system and respective targets having a plurality of fiducial markers;
estimate a respective pose of the one or more targets in the image based on the fiducial markers;
infer, based at least in part on the respective estimated pose of the one or more targets, a state of the mechanical system;
generate, based at least in part on the state, an event; and
process the event.

12. The system of claim 11, wherein the mechanical system is a rear derailleur of a bicycle.

13. The system of claim 11, wherein the processor is further to estimate the pose of one of the one or more targets based at least in part on a spatial relationship of the one of the one or more targets with another of the one or more targets.

14. The system of claim 11, further comprising an output device coupled with the processor, the output device to provide, based at least in part on the event, feedback to a user to adjust an element of the mechanical system.

15. The system of claim 14, further comprising an input device coupled with the output device, the input device to receive, from the user, one or more inputs based on the feedback.

16. The system of claim 14, wherein the output device is a display or a speaker.

17. The system of claim 11, wherein the respective targets have three or more fiducial markers.

18. The system of claim 11, wherein the processor is further to estimate the respective pose of the one or more targets based on one or more parameters related to the camera.

19. The system of claim 11, wherein the parameters are based on an image of a calibration target with at least four fiducial markers.
